(19) United States
(12) Patent Application Publication
(10) Pub. No.: US 2009/0186973 A1
(43) Pub. Date: Jul. 23, 2009

(54) HEAT CURABLE POWDER COATING COMPOSITION

(75) Inventors: Leendert Jan Molhoek, Nunspeet (NL); Jasper Hendrik Johan Dutman, Apeldoorn (NL)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., TE Heerlen (NL)

(21) Appl. No.: 12/015,763

(22) Filed: Jan. 17, 2008

(51) Int. Cl. C08K 3/10; B05D 3/00; C09K 3/00

(52) U.S. Cl. 524/401; 427/384; 252/182.13

(57) ABSTRACT

The invention is directed to a heat curable powder coating composition comprising a polymer comprising functional groups capable of reacting with a β-hydroxyalkylamide unit, a crosslinker comprising β-hydroxyalkylamide units, a first additive comprising a transition-metal cation and a second additive comprising an halogenide anion selected from a iodide or a bromide anion or a combination thereof wherein the halogenide anion is present in a molar excess relative to the transition-metal cation.

Under elevated heat conditions a coating obtained from such a composition shows less yellowing. The invention also relates to a process for manufacturing a coated substrate, to a coated substrate and to the use of the first and second additive. The invention further relates to a crosslinker composition and to a polymer composition.

The invention relates to a heat curable powder coating composition comprising a polymer comprising functional groups capable of reacting with a β-hydroxyalkylamide unit and a crosslinker comprising β-hydroxyalkylamide units. The invention further relates to a process for manufacturing a coated substrate and to a coated substrate. The invention also relates to the use of an additive in a powder coating composition, to a crosslinker composition and to a polymer composition.

Powder coatings are generally known in the art and e.g. described by see Misev T. A. in Powder Coatings, chemistry and technology, John Wilet and Sons, Chichester, 1991.

In general an object is to provide a substrate with a layer of a heat curable powder coating composition and after which the powder coating composition is cured to obtain a coating layer. Often curing occurs at elevated temperature.

Desirable properties of powder coatings include improved optical properties, mechanical properties, chemical resistance against solvents as for example xylene, acteone, alcohols, moisture resistance, thermal resistance and outdoor durability.

Optical properties include but are not limited to appearance which may be colour, gloss, light diffusion by a matt surface, transparency, translucency or opacity also referred to as hiding power.

Mechanical properties include but are not limited to toughness, strength, impact resistance, scratch resistance, flexibility, stiffness or abrasion resistance.

Outdoor resistance includes but is not limited to resistance to conditions such as exposure to salty air, a warm or cool temperature, rain, hail, sand storm or a combination thereof.

EP 0 322 834 B1 discloses a thermosetting powder coating composition comprising a co-reactable particulate mixture of a carboxylic acid group-containing polyester and a beta-hydroxyalkylamide.

A drawback of such powder coating composition is that when exposed to elevated temperatures there is a risk of discolouration which is undesirable. When curing such a composition at a high temperature or a prolonged period of exposure the coating may become yellowish (yellowing).

It is an object of the present invention to reduce yellowing of a powder coating composition caused by exposure to elevated heat conditions. Such elevated heat conditions may be heating to obtain a cured coating layer, a heat overshoot during curing such as a temporary heat peak, or prolonged exposure to curing conditions for instance due to a problem with a curing oven causing the article to remain in the hot oven longer than planned.

This object is achieved by a heat curable powder coating composition comprising
a polymer comprising functional groups capable of reacting with a β-hydroxyalkylamide unit,
a crosslinker comprising β-hydroxyalkylamide units,
a first additive comprising a transition-metal cation
and a second additive comprising an halogenide anion selected from a iodide or a bromide anion or a combination thereof,
   wherein the halogenide anion is present in a molar excess relative to the transition-metal cation.

Under elevated heat conditions a coating obtained from the composition according to the invention shows less yellowing than known compositions.

Surprisingly the use of the first additive comprising a transition-metal cation and the second additive comprising an halogenide anion selected from a iodide or a bromide anion or a combination thereof, wherein the halogenide anion is present in a molar excess relative to the transition-metal cation, reduces yellowing of a composition comprising a crosslinker comprising β-hydroxyalkylamide units under elevated heat conditions (such as curing or baking). Therefore, with the coating composition of the invention a cured coating layer can be obtained showing reduced discolouration, in particular reduced yellowing.

With heat curable is meant within the framework of the current invention that curing of the powder coating composition can be effected by using heat.

The reduced yellowing can be demonstrated by the lower b* value of the coating after cure.

Furthermore the composition according to the invention has a reduced increase of yellowness index (measured as delta b* value) under prolonged and elevated temperature. As can be measured using a heat stability test described herein.

Colour values referred to in this application are values measured using CIE 1976 L, a*, b* colour values (C.I.E.: International Commission on Illumination).

b* is a measure for yellowness: the higher (more positive value for) b* the more yellow the colour of a surface measured is.

In case the coating obtained with a powder coating composition comprising a white pigment such as TiO2 a higher delta E value corresponds to a less white colour.

The polymer may be any polymer comprising functional groups capable of reacting with a β-hydroxyalkylamide unit. Functional groups capable of reacting with a β-hydroxyalkylamide unit include acid functional groups, preferably a carboxylic acid functional group is used.

Examples of suitable polymers include but are not limited to acid functional polymers, wherein the polymer is selected from a group comprising polyester, polyacrylate, polyamide, polyimide, polyurethane and polycarbonate, and copolymers thereof such as polyester-polyimide copolymer and polyester-polyamide copolymer. Preferably, the polymer is selected from a group consisting of polyester, polyacrylate, polyurethane and polycarbonate.

Preferably the polymer comprising functional groups capable of reacting with a β-hydroxyalkylamide unit is selected from a group constiting of carboxylic acid functional polyester, carboxylic acid functional polyacrylate, carboxylic acid functional polyurethane and carboxylic acid functional polycarbonate.

Suitable polyesters may be based for example on a condensation reaction between a linear aliphatic, branched aliphatic and cyclo-aliphatic polyols and an aliphatic, cyclo-aliphatic and/or aromatic poly carboxylic acids or its anhydrides. The ratio of polyol and acids or anhydrides is preferably such that there is an excess of acid or anhydride over alcohol so as to form a polyester which has free carboxylic or anhydride groups.

Polyesters may comprise units of for example, isophthalic acid, terephthalic acid, 2,6-naphthalene dicarboxylic acid, 4,4′-oxybisbenzoic acid, 3,6-dichloro phthalic acid, tetrachloro phthalic acid, tetrahydro phthalic acid, trimellitic acid, pyromellitic acid, hexahydro terephthalic acid (cyclohexane dicarboxylic acid), hexachloro endomethylene tetrahydro phthalic acid, phthalic acid, azelaic acid, sebacic acid, decane dicarboxylic acid, adipic acid, succinic acid, maleic acid, fumaric acid, or mixtures thereof. These acids may be used as such, or, in so far as available as their anhydrides, acid chlorides, and/or lower alkyl esters preferably C1-C3 alkylester.

Preferably, the polyester comprises at least isophthalic acid unit and/or a terephthalic acid unit. Trifunctional or higher functional acids may be used also. Examples of suitable such acids include trimellitic acid or pyromellitic acid. These tri- or higher functional acids may be used as end groups or to obtain branched polyesters.

Hydroxy carboxylic acids and/or optionally lactones may also be used, for example, 12-hydroxy stearic acid, hydroxy pivalic acid or ε-caprolactone.

Monocarboxylic acids may also be used if desired. Examples of these acids include benzoic acid, tert.-butyl benzoic acid, hexahydro benzoic acid and saturated aliphatic monocarboxylic acids.

Suitable polyalcohols are polyalcohols that are reactable with the carboxylic acids to obtain the polyester. Suitable polyalcohols include in particular diols, for example aliphatic diols. Examples of diols include ethylene glycol, propane-1,2-diol, propane-1,3-diol, butane-1,2-diol, butane-1,4-diol, butane-1,3-diol, 2,2-dimethylpropanediol-1,3 (neopentyl glycol), hexane-2,5-diol, hexane-1,6-diol, 2,2-bis-(4hydroxy-cyclohexyl)-propane (hydrogenated bisphenol-A), 1,4-dimethylolcyclohexane, diethylene glycol, dipropylene glycol, 2,2-bis[4-(2-hydroxy ethoxy)-phenyl]propane, the hydroxy pivalic ester of neopentyl glycol, 2-ethyl, 2-butyl propanediol-1,3 (butylethylpropane diol), 2-ethyl, 2-methyl propanediol-1,3 (ethylmethylpropane diol) and 2-methylpropanediol-1,3 (MP-Diol).

Tri- or higher functional alcohols may be used in order to obtain branched polyesters. Examples of suitable such polyols include glycerol, hexanetriol, trimethylol ethane, trimethylol propane, tris-(2-hydroxyethyl)-isocyanurate, penta erythritol and sorbitol.

The polyester may be prepared according to conventional procedures such as by esterification or transesterification, optionally in the presence of customary esterification catalysts for example dibutyltin oxide or tetrabutyl titanate.

The powder coating composition according to the invention comprises a crosslinker comprising units β-hydroxyalkylamide units.

Suitable examples of β-hydroxyalkylamide crosslinkers are described in EP 0322 834 B1 p2, lines 12-36. A suitable commercially available β-hydroxyalkylamide crosslinker is for example N,N,N′,N′-tetrakis-(2-hydroxyethyl)-adipamide (Primid XL-552).

In an aspect of the invention the powder coating composition comprises at least 2 wt. % of crosslinker, by preference at least 3 wt. % and in particular more than 5 wt. % based on the total amount of crosslinker and the polymer present in the powder coating composition. The amount of crosslinker will be generally less than 30 wt. %, preferably less than 20 wt. %, in particular less than 15 wt. % based on the total amount of crosslinker and the polymer present in the powder coating composition. In an aspect of the invention the weight ratio polymer:crosslinker is a range from 98:2 to 80:20, preferably 97:3 to 85:15, more preferably 97:3 to 90:10.

The powder coating composition according to the present invention is preferably a solid composition having a glass temperature (Tg) between 20° C. and 200° C. With solid is here and hereinafter means a compound that is solid at room temperature with the common range of 18° C. to 23° C., at atmospheric pressure usually about 1 bar. A Tg of less than 20° C. gives less physical and/or chemical stability of the system and a Tg more than 200° C. results in a composition which is more difficult to process. More preferably the T_{g} is between 40° C. and 100° C. because this range results in a good combination of chemical stability and processability of the composition.

More preferably the Tg is higher than 45° C., more preferably the Tg is above 50° C. Generally, the higher the Tg, the better the physical stability such as powder stability.

A glass transition temperature (Tg) of at least ca. 40° C. typically results in a stable powder suitable for storage under most common conditions A Tg below ca. 40° C. is usually not preferred as below this temperature powder particles tend to stick and thus hamper the use of the powder.

Additionally a high Tg is advantageous because it usually leads to increased hardness of the final coating. The Tg may be measured by differential scanning calorimetry (DSC) at a scan rate of 5° C./min.

The heat curable powder coating composition according to the invention comprises a first additive comprising a transition-metal cation and a second additive comprising an halogenide anion selected from a iodide or a bromide anion or a combination thereof, wherein the halogenide anion is present in a molar excess relative to the transition-metal cation.

The transition-metal cation in the first additive is preferably in the form of a transition-metal salt or a transition-metal complex, wherein the transition-metal is selected from the groups 4, 5, 6, 7, 8, 9, 10, 11 and 12 of the periodic system of the elements. Suitable metals include Manganese (II) or (III), Iron (II) or (III), Chromium (II) or (III), Cobalt (II) or (III), Copper (I) or (II), Nickel (II) or (III), Rhodium (II), or (III) or (IV) and Ruthenium (I), (II) or (IV), Titanium (III) or (IV), Vanadium (III), (IV) or (V) or a combination thereof.

Suitable counterions for the transition-metal cation include, but are not limited to Iodide, Bromide, Chloride, acetate, acetylacetonate, stearate, propionate, palmitate, 2-ethylhexanoate, neodecanoate or naphtenate.

Preferably Cu(I) or Cu(II) is used as the transition-metal cation, more preferably the transition-metal cation is Cu(I). In an embodiment of the invention the transition-metal cation is a copper-cation.

In practice the first additive may comprise a copper salt. Suitable copper salts, without being limited thereto, are CuSO₄, CuI₂ and CuBr₂. Preferably the copper-salt is a copper-halogenide. Good results were obtained when CuI was used.

It is also possible and within the scope of the invention to use a combination of transition-metal cations and/or a combination of counter anions. So it is for example possible to use copper-chloride together with copper-bromide as the first additive.

The second additive comprises the halogenide anion selected from iodide or bromide anion or a combination thereof. The halogenide anion usually has a counter ion: a counter cation. Examples of suitable counter cations are alkalimetal cations. Preferably the counter cation is potassium and/or sodium, more preferably. The second additive preferably comprises KI, NaI, KBr and NaBr or a combination thereof.

Alternatively an organic halogenide counter cation may be used. An example of an organic halogenide includes NH₄I.

More preferably the second additive comprises KI.

It is within the scope of the invention to use different halogenides as the counter anion of the transition-metal cation and as the halogenide in the second additive.

It is also within the scope of the invention to use the same halogenide as the counter anion in the first additive of the transition-metal cation and as the halogenide in the second additive. For example a combination comprising Cu⁺I⁻ and K⁺I⁻ may be used or a combination of CuBr and KI.

In an aspect of the invention the first additive and the second additive comprise the same compound, for example CuI₂. In this case the Cu cation is both the transition-metal cation and the counter cation for the halogenide anion e.g. iodium.

The ratio between the transition-metal cation and the halogenide anion can be chosen between wide ranges provided that the halogenide anion is present in a molar excess relative to the transition-metal cation.

In a preferred embodiment of the heat curable powder coating composition according to the invention the molar ratio transition-metal cation: halogenide anion is in a range of selected from 1:2 to 1:100, preferably in a range of selected from 1:2 to 1:50.

The amount of the first and second additive added to the powder coating composition will generally depend on the curing and processing conditions. Generally the combined amount of the first and second additive is between 0.05 wt % (weight based on total coating) and 5 wt %, preferably between 0.1 wt % and 3 wt %, more preferably between 0.2 wt % and 0.6 wt %.

In an embodiment of the heat curable powder coating composition according to the invention the invention the transition-metal cation is present in an amount in a range of 5-1000 ppm based on the total composition. A suitable method to determine the amount of transition-metal is Atomic Absorption Spectroscopy (AAS). This method is particularly suitable to detect the transition-metal in a cured coating layer.

In practice the powder coating composition often comprises a colorant and/or a filler

A colorant is defined herein is a substance providing colour to the composition after cure such as a pigment or dye. Examples of pigments are TiO₂, ZnO. Examples of fillers are CaCO₃ and BaSO₄.

The invention is particularly interesting for light coloured coatings such a white coloured coating because a yellowing of a white coating is particularly undesirable. In an aspect of the invention the powder coating composition according to the invention comprises a white pigment such as TiO₂.

Additional stabilizing additives may be used in the heat curable powder coating composition according to the invention. For example primary and/or secondary antioxidants, UV stabilizers for example quinones, (sterically hindered) phenolic compounds, phosphonites, phosphites, thioethers, HALS compounds (hindered amine light stabilizers) or aromatic amines can for example be used as stabilizers.

The invention further relates to a process for manufacturing a coated substrate comprising the steps of:
providing a substrate,
applying the composition according to the invention on the substrate to obtain an at least partly covered substrate,
curing the composition on the at least partly covered substrate.

The invention further relates to a fully or partly coated substrate comprising a coating based on a crosslinked heat curable powder coating composition according to the invention.

The powder coating compositions may be applied to all kinds of substrates.

Examples of suitable materials for substrates include metals, (galvanized) steel, cast iron, aluminium, other metal alloys, glass, ceramics, wood, fibre board such as MDF (medium density fibre board), bricks, plastic, composite and combinations thereof.

The substrate may for example be at least a part of: a piece of garden furniture, a can, a piece of coil, a door, a door frame, a window frame, a heater, a piece of office furniture, a building panel or a building frame.

The invention further relates to a crosslinker composition suitable for reacting with a polymer comprising functional groups capable of reacting with a β-hydroxyalkylamide unit, the crosslinker composition comprising
a crosslinker comprising β-hydroxyalkylamide units,
a first additive comprising a transition-metal cation and
a second additive comprising an halogenide anion selected from a iodide or a bromide anion or a combination thereof, wherein the halogenide anion is present in a molar excess relative to the transition-metal cation.

The crosslinker composition according to the invention provides the desired effect of reduced colouration, in particular less yellowing, if it is mixed with a polymer comprising functional groups capable of reacting with a β-hydroxyalkylamide unit and cured at elevated temperature.

The invention further relates to a polymer composition suitable for reacting with a crosslinker comprising β-hydroxyalkylamide units, the polymer composition comprising
a polymer comprising functional groups capable of reacting with a β-hydroxyalkylamide unit,
a first additive comprising a transition-metal cation and
a second additive comprising an halogenide anion selected from a iodide or a bromide anion or a combination thereof, wherein the halogenide anion is present in a molar excess relative to the transition-metal cation.

The binder composition according to the invention provides the desired effect of reduced colouration, in particular less yellowing, if it is mixed with a polymer comprising functional groups capable of reacting with a β-hydroxyalkylamide unit and cured at elevated temperature.

The invention further relates to the use of a first additive comprising a transition-metal cation and a second additive comprising an halogenide anion selected from a iodide or a bromide anion or a combination thereof wherein the halogenide anion is present in a molar excess relative to the transition-metal cation, as anti-yellowing agent in a powder coating composition comprising
a crosslinker having β-hydroxyalkylamide units,
and a polymer comprising functional groups capable of reacting with a β-hydroxyalkylamide unit.

The use of the first additive comprising a transition-metal cation and the second additive comprising an halogenide anion selected from a iodide or a bromide anion or a combination thereof, wherein the halogenide anion is present in a molar excess relative to the transition-metal cation, reduces colouration of a composition comprising a crosslinker comprising β-hydroxyalkylamide units under elevated heat conditions (such as curing or baking).

The invention is further elucidated by the following non-limiting experiments and examples.

### Experiment 1.

### The Preparation of an Acrylic Polymer (Polymer 4)

A 2 liter reaction flask, equipped with a stirrer, thermocouple, condenser, inlet tubes for nitrogen and monomers and heating mantle, was filled with 250 grams of xylene. The content of the flask was heated to 140° C. A monomer mixture containing 415 gram methyl methacrylate, 50 gram 2-ethyl hexyl acrylate, 150 gram isobornyl methacrylate, 250 n-butyl methacrylate, 93 gram acrylic acid, 20 gram tert-butyl peroxy 2-ethylhexanoate and 20 grams of xylene was prepared. The monomer mixture was added to the reaction flask via a dosing system in 3 hours. After dosing, the mixture was heated for another 3 hours at 140° C. and thereafter the reaction mixture was slowly heated to 200° C., while distilling off the xylene.

Vacuum was applied at 200° C. and distillation was continued for another hour.

The molten polymer was discharged.

The experiment resulted in a solid polymer with an acid value of about 75, a Tg of about 73° C. and a number average molecular weight of about 4500 g/mol.

### EXAMPLES I-III

### The preparation of powder coating compositions:

The polymer-1 (see below) was used to prepare powder coating compositions I, IR.

The polymer-2 (see below) was used to prepare powder coating compositions II, IIR.

The polyacrylate polymer according to Experiment 1 was used to prepare powder coating compositions III and IIIR.

The powder coating compositions were prepared by using the following procedures:
1) As indicated in Table 1 the polyester polymers 1 and 2 , a β-hydroxyalkylamide unit comprising crosslinker (Primid® XL-552), a flow aid (Resiflow® PV-5) and a degassing agent (Benzoine) were mixed in an extruder at 110-130° C. The extrudate was cooled, grinded and sieved. The sieve fraction smaller than 90 micrometers was used for the powder coating composition.
2) As indicated in Table 2 the polyacrylate polymer according to Experiment 1, a β-hydroxyalkylamide unit comprising crosslinker (Primid ® XL-552), a flow aid (Resiflow® PV-5), a white pigment (Kronos® 2160) and a degassing agent (Benzoine) were mixed in an extruder at 120° C. The extrudate was cooled, ground and sieved. The sieve fraction smaller than 90 micrometers was used for the powder coating composition.

### Manufacturing of a Coating

The powder coatings I-III and IR-IIIR each were sprayed electrostatically onto separate aluminum panels (ALQ-46).

The panels were cured in an electric oven under the conditioned mentioned in the tables.

This way coatings I-III and IR-IIIR were obtained.

### Test Methods

The various tests were performed on the cured coatings according to the following methods:

### Colour

Colour values referred to in this application are values measured on the surface of the coating using CIE 1976 L, a*, b* colour values (C.I.E.: International Commission on Illumination). The colour values were measured according to DIN 6174 using a Dr. Lange Micro colour II apparatus.

### Heat Stability Test

The substrates comprising one of the coatings I-III, IR-IIIR obtained as described above were cut in two parts.

The first part was kept as reference. The second part was subjected to a heat stability test by heating the cured panel for 60 minutes at 220° C. in an electric oven.

The colour of the coating on the first and the second part was measured as described above. The results are listed in table 3.

### NOx Resistance Test/‘Cure Under NOx Conditions’.

After spraying the powder coating compositions according to table 1, 2 onto an aluminium panel, the panel was heated for 2 min at 160° C. to melt the powder onto the panel.

The panel was cut in two parts.

The first part was cured in an electric oven.

The second part was cured separately in the same oven while a flow of NOx gas was lead through the electric oven this is referred to as ‘cure under NOx conditions’.

The curing under the flow of NOx gas is a simulation test for gas oven curing.

The colour of the coating on the first and the second part was measured as described above. The results are listed in table 4.

TABLE 1

| Composition | IR* | I | IIR* | II |
|---|---|---|---|---|
| Polymer 1 (Uralac ® P825) | 285 | 285 | | |
| Polymer 2 (Uralac ® P865) | | | 285 | 285 |
| Primid ® XL-552 | 15 | 15 | 15 | 15 |
| Kronos ® 2160 | 150 | 150 | 150 | 150 |
| Resiflow ® PV-5 | 4.5 | 4.5 | 4.5 | 4.5 |
| Benzoin | 1.25 | 1.25 | 1.25 | 1.25 |
| Bruggolen H-3336 | | 0.4 | | 0.4 |

*R indicates a comparative example, so composition IR is a comparative to composition I.

Polymer-1 is a carboxylated polyester commercially available as Uralac® P825 (also known as a carboxylated polyester powder coating resin) suitable for use with Primid® XL-552 (a beta hydroxyl alkylamide) and having the following characteristics: Acid Value 33-37, Viscosity 10-30 dPa·s, Tg about 50 □C. Uralac® P825 was obtained from DSM N.V.

Polymer-2 is a carboxylated polyester commercially available as Uralac® P865 (also known as a carboxylated polyester powder coating resin) suitable for use with Primid® XL-552 and having the following characteristics: Acid Value 33-37, Viscosity 15-30 dPa·s, Tg about 56 □C. Uralac® P865 was obtained from DSM N.V.

Primid XL-552 is a betahydroxy alkylamide crosslinker obtainable from EMS-chemie A.G., Switzerland.

Kronos 2160 is a pigment obtainable from Kronos Europe.

Resiflow PV-5 is a flow additive obtainable from Worlee Chemie Gmbh.

Benzoin is a degassing agent obtainable from Caffaro SpA Italy.

Bruggolen H-3336 is a copper-halogenide obtainable from Brüggeman Chemical, Germany.

TABLE 2

| Composition | IIIR* | III |
|---|---|---|
| Polymer-3 | 91 | 91 |
| Primid ® XL-552 | 9 | 9 |
| Kronos ® 2160 | 50 | 50 |
| Resiflow ® PV-5 | 1.5 | 1.5 |
| Benzoin | 0.75 | 0.75 |
| Bruggolen H-3336 | — | 0.8 |

*R indicates a comparative example, so IIIR is a comparative to III

TABLE 3
Cure and Heat stability

| | | | | | |
|---|---|---|---|---|---|
| IR* | I | IIR* | II | IIIR | III |

After cure
I-II and IR-IIR: 10 min. at 180 [symbol] C.
III, IIIR: 15 min. at 180 [symbol] C.

| | | | | | | |
|---|---|---|---|---|---|---|
| Colour b*_{Cure} | 2.0 | 0.4 | 1.4 | 0.6 | 2.3 | 1.2 |

After heat stability test:
additional 60 min. at 220 [symbol] C.

| | | | | | | |
|---|---|---|---|---|---|---|
| Colour b*_{Cure+heat test} | 5.6 | 3.1 | 7.5 | 3.4 | 6.2 | 3 |
| Colour change: | 3.6 | 2.7 | 6.6 | 2.9 | 3.9 | 1.8 |
| delta b* = b*_{Cure+heat test} − b*_{Cure} | | | | | | |
| Colour change: | 4.0 | 2.7 | 6.6 | 2.9 | 4.4 | 1.9 |
| delta E = (L_{Cure+heat test} − L_{Cure})² + | | | | | | |
| (a*_{Cure=heat test} − a*_{Cure})² + | | | | | | |
| (b*_{Cure+heat test} − b*_{Cure})² | | | | | | |

*R: comparative example: e.g. IR is comparative example for I etc.

The yellowness (colour b*) of coating I after cure for 10 min. at 180 [symbol] C is less than the yellowness (colour b*) of coating IR cured under the same conditions; the yellowness of the coating according to the invention (I-III) is reduced relative to the corresponding comparative coatings (IR-III resp.).

After the heat stability test the yellowness (colour b*) of coating I is less than the yellowness (colour b*) of coating IR subjected to the same test. The yellowness (colour b*) of coating I is reduced relative to coating IR under prolonged exposure to elevated temperature.

The reduction of yellowing was observed after curing the composition according to the invention in an electrical oven and after curing in a test simulating gas oven conditions.

A colour robustness is defined as the difference between the colour after cure and the colour after a subsequent additional heating conditions. The colour robustness of the coating according to the invention is larger than the coating robustness of the corresponding comparative coatings without the additive: the colour change delta b* and the colour change delta E are smaller for coatings I-III than for corresponding coatings IR-IIIR.

TABLE 4
NOx resistance test

| | IR | I | IIR | II | IIIR | III |
|---|---|---|---|---|---|---|
| After cure (no NOx gas: ‘cure’) | 3.2 | 0.4 | 2.1 | 0.6 | 2.5 | 1.5 |
| I-II and IR-IIR: for 20 min. at 185 [symbol] C. | | | | | | |
| III and IIIR: for 15 min. at 185 [symbol] C. | | | | | | |
| colour b*: | | | | | | |
| After cure under NOx gas flow (‘cure | 6.9 | 2.2 | 5.0 | 3.0 | 3.4 | 2.7 |
| under NOX gas’) | | | | | | |
| I-II and IR-IIR: for 20 min. at 185 [symbol] C. | | | | | | |
| III and IIIR: for 15 min. at 185 [symbol] C. | | | | | | |
| colour b*: | | | | | | |

The yellowness (colour b*) of coating I, II and III after ‘cure under NOx gas’ for 20 min. at 185 [symbol] C is less than the yellowness (colour b*) of coating IR, IIR, IIIR resp. cured under the same conditions; the yellowness of the coating according to the invention (I, II, II) is reduced relative to the corresponding comparative coatings (IR, IR, IIIR resp.) in a gas oven simulation test.

The colour of the coating according to the invention in a gas oven simulation test is less than the colour coating of the corresponding comparative coatings without the additive: the colour delta b* is smaller for coatings I-II than for corresponding coatings IR-IIR resp.

1. A heat curable powder coating composition comprising
a polymer comprising functional groups capable of reacting with a hydroxyalkylamide unit,
a crosslinker comprising β-hydroxyalkylamide units,
a first additive comprising a transition-metal cation
and a second additive comprising an halogenide anion selected from a iodide or a bromide anion or a combination thereof
wherein the halogenide anion is present in a molar excess relative to the transition-metal cation.

2. The composition according to claim 1, wherein in that the molar ratio transition-metal cation: halogenide anion is in a range of selected from 1:2 to 1:100.

3. The composition according to claim 1, wherein in the transition-metal cation is a copper-cation.

4. The heat curable powder coating composition according to claim 1, wherein the transition-metal cation is present in an amount in a range of 5-1000 ppm based on the total composition.

5. A process for manufacturing a coated substrate comprising the steps of
providing a substrate,
applying the composition according to claim 1 on the substrate to obtain an at least partly covered substrate,
curing the composition on the at least partly covered substrate.

6. A fully or partly coated substrate comprising a coating based on a crosslinked powder coating composition according to claim 1.

7. A use of a first additive comprising a transition-metal cation and a second additive comprising an halogenide anion selected from a iodide or a bromide anion or a combination thereof, wherein the halogenide anion is present in a molar excess relative to the transition-metal cation, as anti-yellowing agent in a powder coating composition comprising
a crosslinker having β-hydroxyalkylamide units,
and a polymer comprising functional groups capable of reacting with a hydroxyalkylamide unit.

8. A crosslinker composition suitable for reacting with a polymer comprising functional groups capable of reacting with a β-hydroxyalkylamide unit, the crosslinker composition comprising
a crosslinker comprising β-hydroxyalkylamide units,
a first additive comprising a transition-metal cation and
a second additive comprising an halogenide anion selected from a iodide or a bromide anion or a combination thereof, wherein the halogenide anion is present in a molar excess relative to the transition-metal cation.

9. A polymer composition suitable for reacting with a crosslinker comprising β-hydroxyalkylamide units, the polymer composition comprising
a polymer comprising functional groups capable of reacting with a β-hydroxyalkylamide unit,
a first additive comprising a transition-metal cation and
a second additive comprising an halogenide anion selected from a iodide or a bromide anion or a combination thereof wherein the halogenide anion is present in a molar excess relative to the transition-metal cation.
